(19) United States
(12) Patent Application Publication
(10) Pub. No.: US 2010/0065137 A1
(43) Pub. Date: Mar. 18, 2010

(54) Spill Prevention System for Vented Marine Fuel Tanks

(76) Inventor: Gary Armellino, Jacksonville, FL (US)

Correspondence Address: ROGERS TOWERS, P.A., 1301 RIVERPLACE BOULEVARD, SUITE 1500, JACKSONVILLE, FL, 32207, US

(21) Appl. No.: 12/584,921

(22) Filed: Sep. 15, 2009

Related U.S. Application Data
(60) Provisional application No. 61/192,071, filed on Sep. 15, 2008.

(51) Int. Cl. B63B 25/08

(52) U.S. Cl. 137/587

(57) ABSTRACT

A spill preventing system for vented marine fuel tanks incorporates a capture reservoir at the discharge end of the vent conduit extending from the tank, such that any fuel forced into the vent conduit during the filling operation is temporarily retained within the capture reservoir and returned to the tank and is not ejected through the vent port into the environment.

This application claims the benefit of U.S. provisional patent Applications Ser. No. 61/192,071, filed Sep. 15, 2008.

### BACKGROUND OF THE INVENTION

This invention relates generally to the field of fuel system and tank assemblies in vehicles, such as gasoline or diesel tanks, and more particularly to vented fuel tanks, such as marine fuel systems found in boats.

Fuel tanks require a venting system of some type such that air within the tank has an escape pathway separate from the inlet fill pipe that is receiving the fuel. In marine applications, such as the fuel tanks found on pleasure boats and the like, the marine fuel tank is typically provided with a vent conduit connected to a vent port mounted on the side of the hull, thus providing a direct passage of fuel overboard. The vent conduit is typically of much smaller diameter than the fill conduit. Even with the smaller diameter, when the tank is approaching full capacity, a significant amount of fuel is often ejected through the vent port. While each individual incident results in only a small amount of pollution, the cumulative total of fuel spillage from thousands and thousands of boats every day produces an unacceptable amount of pollution and harm to the environment.

It is an object of this invention to provide a spill preventing system for vented marine fuel tanks that captures any fuel forced into the vent conduit prior to it being ejected through the vent port into the environment. It is a further object to provide such a system wherein any fuel forced into the vent conduit is returned to the fuel tank.

### SUMMARY OF THE INVENTION

The spill preventing system for vented marine fuel tanks may comprise several embodiments, all of which embodiments include a fuel capture reservoir. In a first embodiment, the fuel tank system comprises an fill conduit to receive the fuel, a tank, a vent conduit of smaller diameter than the fill conduit, a vent port extending through the hull of the boat, and an internally mounted fuel capture reservoir disposed between the vent conduit and the vent port. In a second embodiment, the fuel tank system comprises an fill conduit to receive the fuel, a tank, a vent conduit of smaller diameter than the fill conduit, a vent port extending through the hull of the boat, an internally mounted fuel capture reservoir disposed between the vent conduit and the vent port, and a return conduit extending between the fuel capture reservoir and the fuel tank. In a third embodiment, the fuel tank system comprises a fill conduit to receive the fuel, a tank, a vent conduit of smaller diameter than the fill conduit, a vent port extending through the hull of the boat, an internally mounted fuel capture reservoir disposed between the vent conduit and the vent port, and a return conduit extending from the fuel capture reservoir back to the fill conduit. These spill preventing systems may be utilized in conjunction with charcoal or other fume suppressing enhancements, and a one-way valve may be incorporated into the return conduits to prevent flow in the wrong direction.

### BRIEF DESCRIPTION OF THE DRAWINGS

FIG. 1 is a cross-sectional view of a first embodiment of the spill preventing system for vented marine fuel tanks.

FIG. 2 is a cross-sectional view of a second embodiment of the spill preventing system for vented marine fuel tanks.

FIG. 3 is a cross-sectional view of a third embodiment of the spill preventing system for vented marine fuel tanks.

### DETAILED DESCRIPTION OF THE INVENTION

With reference to the drawings, the invention will now be described in detail with regard for best mode and preferred embodiments. In general, the invention is a spill preventing system for vented marine fuel tanks, whereby any fuel that is forced into the vent conduit is captured and returned to the fuel tank rather than being expelled into the environment.

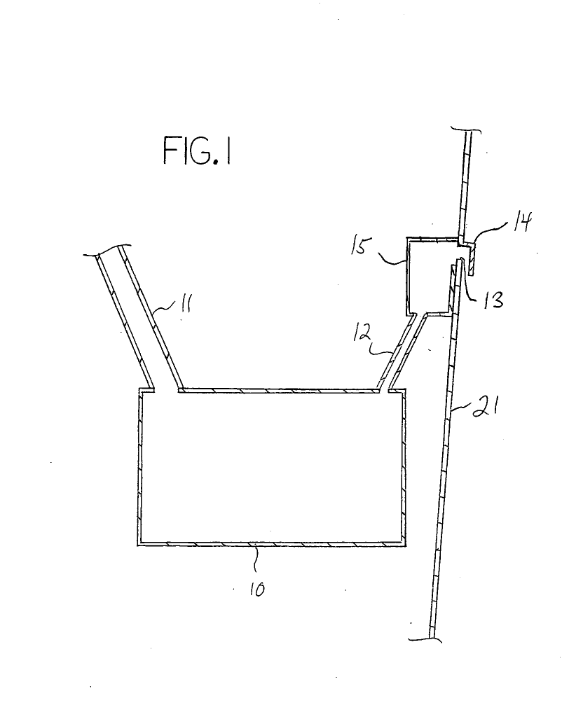

A first embodiment of the spill preventing system for vented marine fuel tanks is shown in FIG. 1. A fill conduit 11 is connected to a fuel tank 10 such that fuel can be delivered into the tank 10. In order to allow air to be displaced as the tank 10 is being filled with fuel, a vent conduit 12 is provided—the vent conduit 12 being mounted in communicating manner to the top or upper portion of the fuel tank 10. The fill conduit 11 and vent conduit 12 may be composed of any suitable material, such as metal, rubber or plastic, and may be rigid or flexible. The vent conduit 12 is of much smaller diameter than the fill conduit 11. Instead of the vent conduit 12 connecting directly to the vent port 13 in the boat hull 21, as is conventional, a fuel capture reservoir 15 is provided internally to the vent port 13 and the vent conduit 12 is connected to the bottom of the fuel capture reservoir 15. The internal volume of the fuel capture reservoir 15 is significantly greater than the internal volume of the vent conduit 12. The fuel capture reservoir 15 is positioned such that a relatively large amount of fuel can be retained in the fuel capture reservoir 15 beneath the level of the vent port 13. A vent cover 14 may be provided externally to the vent port 13 to prevent ingress of rainwater, water from washing the boat, etc.

With this construction, as fuel is delivered into the tank 10 through fill conduit 11, the rising fuel level within tank 10 causes air to pass out through the vent conduit 12, the fuel capture reservoir 15 and vent port 13. As the tank 10 becomes fully filled, backflow pressure into the fill conduit 11 results in automatic cut-off of the fuel delivery in known manner. However, this cut-off may not occur rapidly enough, in which case a quantity of fuel is forced up into the vent conduit 12. Rather than being ejected from the vent port 13 as would occur in normal situations, this fuel enters the fuel capture reservoir 15 and is retained therein, the location of the vent port 13 relative to the position of the fuel capture reservoir 15 being such that a relatively large amount of fuel will collect in the fuel capture reservoir 15 prior to the level of the fuel reaching the vent port 13. Once the fueling operation ceases, any fuel retained within the fuel capture reservoir 15 now drains back into the tank 10 through the vent conduit 12.

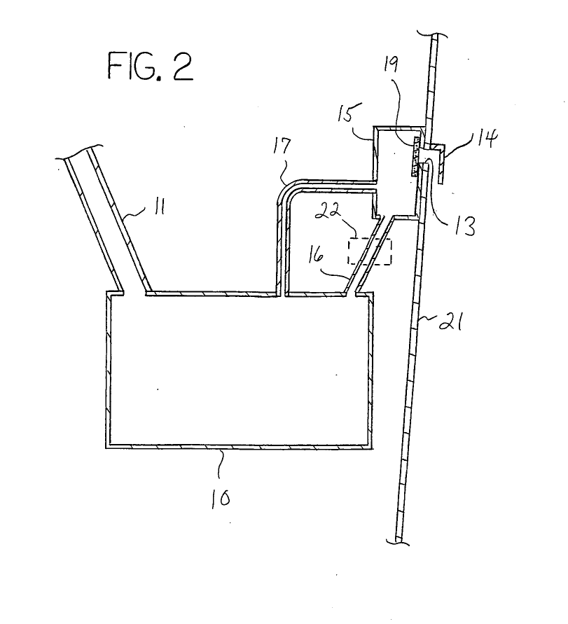

In a second embodiment of the invention, as shown in FIG. 2, the system comprises a vent conduit 17 and a separate return conduit 16. The vent conduit 17 preferably connects to the fuel capture reservoir 15 preferably at the level of or beneath the level of the vent port 13. The return conduit 16 connects to the bottom of the fuel capture reservoir 15. In this system, any fuel that is forced up the vent conduit 17 and into the fuel capture reservoir 15 will be momentarily retained by the fuel capture reservoir 15 and returned to the tank 10 through return conduit 16. Optionally, a one-way valve or restrictor 22 that allows only return flow in return conduit 16 may be provided in conjunction with return conduit 16 such that fuel cannot be forced from tank 10 into the fuel capture reservoir 15 through return conduit 16. The one-way valve 22 may be positioned at either end of the return conduit 16 or at any intermediary point.

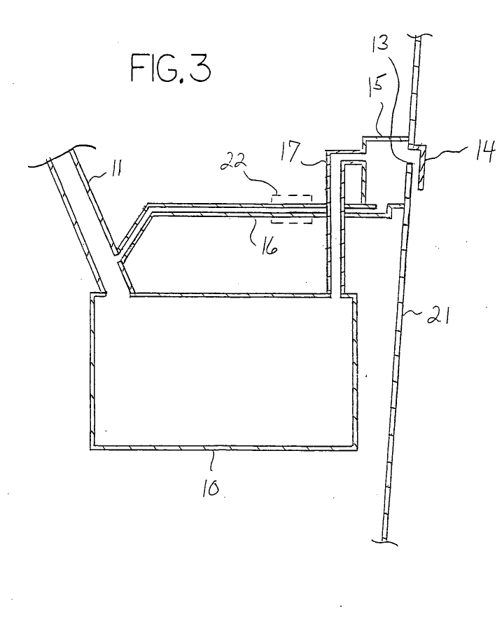

A third embodiment is shown in FIG. 3. In this embodiment the return conduit 16 connects the fuel capture reservoir 15 to the larger diameter fill conduit 11. As before, an optional one-way valve may be provided in conjunction with the return conduit 16. The one-way valve 22 may be positioned at either end of the return conduit 16 or at any intermediary point.

In order to prevent or reduce fuel vapors from passing into the environment through the vent port 13, a vapor-suppressing filter 19 may be disposed across the vent port 13 with suitable mounting means, as shown in FIG. 2. For example, the vapor-suppressing filter 19 may contain activated charcoal or like material.

It is understood that equivalents and substitutions for certain elements and structures set forth above may be obvious to those skilled in art, and therefore the true scope and definition of the invention is to be as set forth in the following claims.

1. A marine fuel tank spill preventing system, said system comprising in combination:
a fuel tank,
an inlet conduit connected to said fuel conduit whereby fuel is delivered through said inlet conduit into said fuel tank,
a vent port,
a fuel capture reservoir positioned adjacent said vent port, and
a vent conduit connecting said fuel tank to said fuel capture reservoir,
whereby during a fuel filling operation air is vented through said vent conduit into said fuel capture reservoir and out said vent port,
and whereby fuel displaced from said fuel tank into said vent conduit is retained within said fuel capture reservoir, such that no said displaced fuel is ejected through said vent port during the fuel filling operation.

2. The system of claim 1, further wherein said displaced fuel drains from said fuel capture reservoir back into said fuel tank through said vent conduit after the fuel filling operation is concluded.

3. The system of claim 2, wherein the diameter of said inlet conduit is greater than the diameter of said vent conduit.

4. The system of claim 2, further comprising a vent cover positioned on said vent port.

5. The system of claim 2, further comprising a vapor-suppressing filter disposed across said vent port.

6. The system of claim 1, further comprising a return conduit connecting said fuel capture reservoir to said fuel tank.

7. The system of claim 6, wherein said displaced fuel drains back into said fuel tank through said return conduit after the fuel filing operation is concluded.

8. The system of claim 7, further comprising a one-way valve disposed with said return valve, such that said displaced fuel may only flow from said fuel capture reservoir to said fuel tank.

9. The system of claim 7, wherein the diameter of said inlet conduit is greater than the diameter of said vent conduit.

10. The system of claim 7, further comprising a vent cover positioned on said vent port.

11. The system of claim 7, further comprising a vapor-suppressing filter disposed across said vent port.

12. The system of claim 1, further comprising a return conduit connecting said fuel capture reservoir to said inlet conduit.

13. The system of claim 12, wherein said displaced fuel drains back into said fuel tank through said return conduit and said inlet conduit after the fuel filing operation is concluded.

14. The system of claim 13, further comprising a one-way valve disposed with said return valve, such that said displaced fuel may only flow from said fuel capture reservoir to said inlet conduit.

15. The system of claim 13, wherein the diameter of said inlet conduit is greater than the diameter of said vent conduit.

16. The system of claim 13, further comprising a vent cover positioned on said vent port.

17. The system of claim 13, further comprising a vapor-suppressing filter disposed across said vent port.

18. A marine fuel tank spill prevention system mounted within a boat hull, said system comprising in combination:
a fuel tank,
an inlet conduit connected to said fuel conduit whereby fuel is delivered through said inlet conduit into said fuel tank,
a vent port passing through a boat hull,
a fuel capture reservoir positioned adjacent said vent port internally to said boat hull, and
a vent conduit connecting said fuel tank to said fuel capture reservoir,
whereby during a fuel filling operation air is vented through said vent conduit into said fuel capture reservoir and out said vent port, and
whereby fuel displaced from said fuel tank into said vent conduit is retained within said capture reservoir, such that no said displaced fuel is ejected through said vent port during the fuel filling operation, and further such that said displaced fuel drains from said fuel capture reservoir back into said fuel tank through said vent conduit after the filling operation is concluded.

19. In a marine fuel tank spill prevention system comprising:
a fuel tank,
an inlet conduit connected to said fuel conduit whereby fuel is delivered through said inlet conduit into said fuel tank,
a vent port passing through a boat hull, and
a vent conduit connecting said fuel tank to said vent port,
the improvement comprising a fuel capture reservoir positioned between vent conduit and said vent port,
whereby during a fuel filling operation air in said fuel tank is vented through said vent conduit into said fuel capture reservoir and out said vent port, and
whereby fuel displaced from said fuel tank into said vent conduit is retained within said capture reservoir, such that no said displaced fuel is ejected through said vent port during the fuel filling operation, and further such that said displaced fuel drains from said fuel capture reservoir back into said fuel tank through said vent conduit after the filling operation is concluded.
